(19) United States
(12) Patent Application Publication
(10) Pub. No.: US 2017/0127654 A1
(43) Pub. Date: May 11, 2017

(54) APPARATUS AND METHOD FOR POULTRY HOUSE FLOOR

(71) Applicant: Tyson Foods, Inc., Springdale, AR (US)

(72) Inventors: Doug Foreman, Springdale, AR (US); Daniel M. Evans, Springdale, AR (US); David Lee Mantooth, Fayetteville, AR (US); Stephen Brannan, Wesley, AR (US)

(21) Appl. No.: 15/410,905

(22) Filed: Jan. 20, 2017

Related U.S. Application Data
(63) Continuation of application No. 14/034,222, filed on Sep. 23, 2013.

(51) Int. Cl. A01K 31/04; A01K 1/015; A01K 1/01; A01K 31/22; A01K 39/04

(52) U.S. Cl. CPC A01K 31/04; A01K 31/22; A01K 39/04; A01K 1/0146; A01K 1/0152

(57) ABSTRACT

A poultry house has a floor with a surface area. Lifter covers substantially the entire surface area of the floor. A nourishment dispensing device, which is preferably a water trough or other watering device, is preferably positioned above the floor and litter in a nourishment area. A platform is located in the nourishment area above the litter and floor, and below the nourishment dispensing device. The platform is preferably comprised of a grate or a series of slats, and preferably extends throughout substantially the entire nourishment area. The platform is constructed with through-holes or slits which are structured to allow liquids, such as, to pass through the platform to the lifter below. However, the through-holes or slits are not so large as to allow the feet of chicken or other poultry from passing there through to make contact with the wet litter below.

### CROSS REFERENCE

This application is a Continuation Of U.S. patent application Ser. No. 14/034,222 filed on Sep. 23, 2013 entitled POULTRY HOUSE WITH COMBINATION LITTER AND SLATS. The entire disclosure of the above-identified application is incorporated herein by reference.

### FIELD OF DISCLOSURE

The present invention relates generally to poultry house, and more specifically to a poultry house floor design in the area of the watering trough.

### BACKGROUND OF THE INVENTION

Background Art:

Poultry farms raise domesticated birds such as chickens, turkeys, ducks, and geese, for the purpose of harvesting meat or eggs for food. Poultry is farmed in great numbers, with chickens being the most numerous. Therefore, for convenience, reference will be made specifically to chickens hereinafter, although it is to be understood that the invention is not limited to chickens. More than 50 billion chickens are raised annually as a source of food, for both their meat and their eggs. Chickens raised for eggs are usually called layers while chickens raised for meat are often called broilers or fryers, depending on their size and suitability for various cooking methods. Many parts of a chicken are consumed as food, including their feet. Therefore, keeping chickens' feet clean, and healthy is important.

Generally, chickens are housed in chicken houses (houses), such as the example prior art chicken house shown in FIG. 1. Traditionally, the floor of a chicken house is often covered in wood chips or sawdust, also called litter. This litter helps to somewhat absorb the chickens' droppings, leaking water, etc. The litter can be easily cleaned out and replaced, as needed. Other houses may utilize elevated slats or grating in place of litter on the floor. The chickens' droppings, leaking water, etc. can simply drop through the holes and gaps in the floor, thereby removing all or most of it from proximity to the chickens.

However, litter floors and grated flooring both have downsides. As chicken droppings, and leaking water fall onto litter floors, these substances are simply absorbed into or are mixed with the litter. The chickens continue to walk through the effected litter, and are therefore in contact with moisture from the droppings and water. In such an environment, the chickens' feet are particularly at risk, for foot pad dermitis. This is particularly the case where watering troughs or modem drinking lines are located resulting in water leakage and additional dampness in the litter. Elevated grate floors used in lieu of litter covered floors do serve to elevate the chickens from droppings and damp litter, however, elevated grate floors can injure the feet of a chicken.

Accordingly, there is a need for a poultry coop or housing with flooring that protects the chickens, and particularly their feet, from continual contact with damp litter and droppings, and from injury due to walking on grated floors.

### BRIEF SUMMARY OF DISCLOSURE

According to one aspect of the present invention, a poultry house has a floor with a surface area. Litter, which may consist of wood chips or sawdust or the like, covers substantially the entire surface area of the floor. A nourishment area is a subset of the surface area of the floor. Preferably the nourishment area is the portion of the surface area of the floor above which a nourishment dispensing device resides. The nourishment dispensing device, which can include a water trough or other watering device, is preferably positioned above the floor and litter in the nourishment area. The watering devices can generally be referred to as drinkers and the troughs can be elongated or in the form of a small cup shaped vessel, generally referred to as a watering cup. The nourishment area is preferably larger than the nourishment device, or stated another way, larger than the nourishment device's projected area onto the floor, to account for any splashing or sloshing that may occur in or near the nourishment device.

A platform is located in the nourishment area above the litter and floor, and below the nourishment device. The platform is preferably comprised of a grate or a series of slats, and preferably extends throughout substantially the entire nourishment area. The platform is constructed with through-holes or slits which are structured to allow droppings and water, to pass through the platform to the litter below. The nourishment area is relatively sized to be a relatively small portion of an entire surface area of the floor such that a poultry is able to walk on litter over most of the surface area of the floor, which is clearly illustrated in FIGS. 1-6. However, the through-holes or slits are not so large as to allow the feet of chicken or other poultry from passing there through to make contact with the wet litter below. The platform may be immediately above the litter resting atop the bed of litter, or another implementation could be slightly elevated, such as about 1 cm above the litter. The platform may alternatively be elevated off of the litter by about 5 centimeters or more.

The platform may be made of any suitable material, which is preferably waterproof and substantially impermeable to bacteria. For example, metal, plastics and/or treated wood may be used to construct the platform.

By placing the platform over only a portion of the surface area of the floor immediately above the litter, the chickens in the house are not forced to walk solely on the platform. Rather, the chickens have the option of walking on litter over most of the house. The nourishment area, hence the platform is clearly relatively sized, as reflected in FIGS. 1-6, to be a relatively small portion of an entire surface area of the floor such that a poultry is able to walk on litter over most of the surface area of the floor. However, in the area where the lifter is most likely to be wet, i.e., in the nourishment area beneath the watering trough, the chickens are raised above the wet litter by the platform. The water and droppings may still pass through the platform to the lifter below, but the chickens do not have to continuously walk through the litter which is most likely to be wet and subject to contamination. The proposed implementation as described and claimed herein provides a greater economy of construction and makes it easier to retrofit existing poultry houses. Existing buildings can be utilized without the need for building a support structure for elevated slatted flooring. Service personnel will need access to the areas where the chickens reside to provide feed, water, temperature control, and ventilation as well as remove manure. If the entire area is slatted, the structure to support the service personnel can become very cumbersome and costly to support and move for repair, cleaning and removal of manure. The slat/litter combination provides benefit to the chickens while still allowing traditional methods of catching in an existing facility because the same access is provided to the service personnel with the implementation as described and claimed herein. Existing buildings can be retrofitting economically while gaining the benefit of the slatted areas and while greatly benefiting the chickens and while allowing the service personnel unencumbered access for care and harvesting of the chickens.

### BRIEF DESCRIPTION OF THE SEVERAL VIEWS OF THE DRAWING

FIG. 1 shows a perspective view of a prior art chicken house with a litter floor.

FIG. 2 shows a perspective view of a chicken house according to an embodiment of the current invention.

FIG. 3 shows a transverse cross-sectional side elevation view taken across line A-A of FIG. 2.

FIG. 4 is an illustration of a broiler house.

FIG. 5 is an illustration of a winch system for raising the water system and floor slats for maintenance.

FIG. 6 is a top view of the water system and the slatted flooring positioned under the water system.

While the disclosure is susceptible to various modifications and alternative Bonus, specific embodiments thereof are shown by way of example in the drawings and will herein be described in detail. It should be understood, however, that the drawings and detailed description presented herein are not intended to limit the disclosure to the particular embodiment disclosed, but on the contrary, the intention is to cover all modifications, equivalents, and alternatives falling within the spirit and scope of the present disclosure as defined by the appended claims.

### DETAILED DESCRIPTION OF THE INVENTION

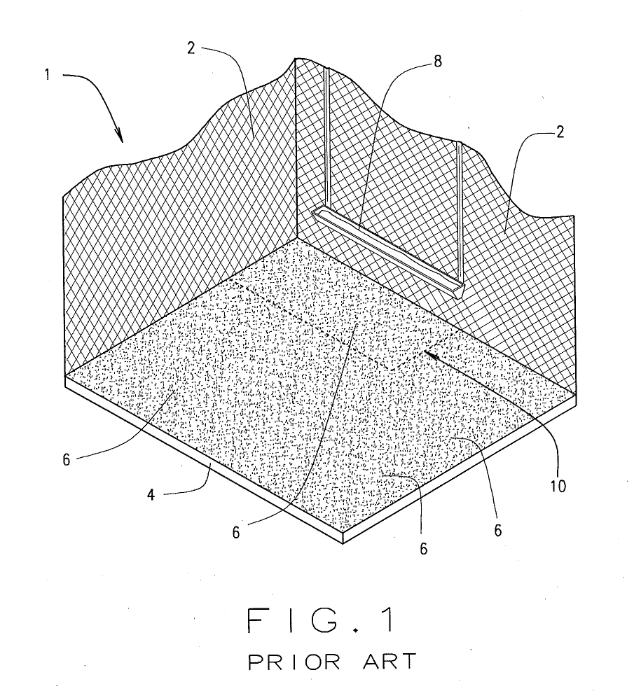

A prior art chicken house 1 is shown in FIG. 1. Prior art chicken houses typically include walls 2 enclosing a floor 4. The walls 2 may be made of chicken wire. The floor 4 typically has a surface area which is substantially covered by litter 6. Litter 6 is typically composed of wood chips or sawdust or the like. A nourishment dispensing unit 8, which can be a water trough but which may include a food dispenser, is located in an area which can be designated as a nourishment area 10. The litter 6 preferably extends all of the way into the nourishment area 10, and thereby covers the floor 4 below the nourishment dispensing unit 8.

When chickens in a prior art house 1 drink and/or splash water or other liquids from the nourishment dispensing unit 8, or evacuate onto the litter 6 in the nourishment area 10, the litter 6 in the nourishment area 10 becomes wet with water, droppings or other liquids. Such litter 6 thereby can be contaminated and/or harbor bacteria. Therefore, in order to obtain nourishment from the nourishment dispensing device 8, chickens must walk through litter 6 which is likely to be the wettest area in the house 1.

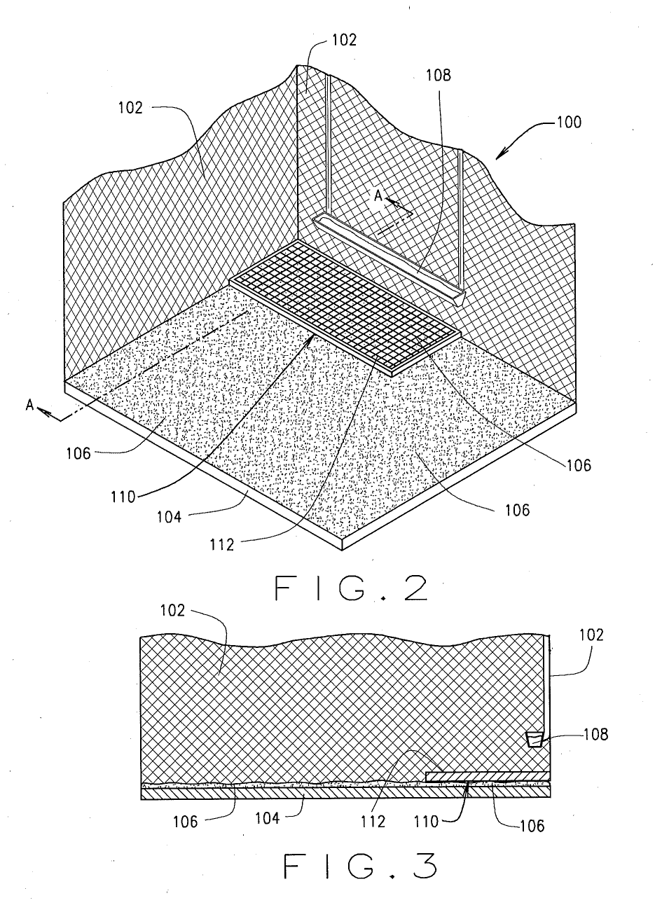

FIGS. 2 and 3 illustrate an embodiment of an improved chicken house 100. As can be seen in FIG. 2, the same walls 102 and floor 104 are present. Substantially the entire surface area of floor 104 is preferably still covered with litter 106. The nourishment dispensing device 108 is still positioned above an area which can be referred to as a nourishment area 110, and the litter 106 still extends substantially throughout the nourishment area 110. However, in the nourishment area 112, a platform 112 is now present on top of the litter 106 and below the nourishment dispending unit 108. The platform 112 preferably extends throughout the nourishment area 110.

As shown in FIG. 2, the platform 112 is a grate with a plurality of through-holes therein. Alternatively, the platform 112 may include a series of slats with open slits there between. In either case, the through-holes and/or slits are preferably sized and positioned to allow droppings and water which fall within the nourishment area 110 to pass through the platform 112 to the litter 106 below. However, the through-holes and/or slits are preferably sized and positioned to prevent a chicken's foot from passing there through. Specifically, the through-holes or slits of the platform 112 are preferably smaller in diameter than the average chicken foot. Thus, the platform 112 substantially prevents chickens from coming into contact with the litter 106 below the platform 112 in the nourishment area 110. Further, the chickens are preferably not injured by accidentally stepping through the platform and getting caught. The individual pieces of litter 106 can be sized sufficiently small to extend partially through the openings of the platform 112 without extending completely there through. Thereby, the litter 106 would still not make contact with the feet of the bird, but may provide better wicking away of any moisture.

As can be best seen in FIG. 3, which is a cross-sectional side elevation view of FIG. 2 taken about line A-A, the platform 112 may be positioned immediately above the litter 106. In one implementation, the platform 112 may be positioned about 1 centimeter above the litter 106. However, other implementations include a platform 112 which is more than 5 centimeters above the litter 106. The platform 112 is preferably positioned below the nourishment dispensing unit 108.

The platform 112 may be composed of any material, although waterproof materials are preferred. Also, the platform 112 is preferably made out of a material that is resistant to microbial growth and/or impermeable to bacteria. For example, many metals and plastics would be suitable. Wood may also be used, but such wood is preferably treated so as to be water resistant and/or less permeable to bacteria. Non-suitable substances may also be coated with a suitable plastic substance. For example, the platform 112 may be a wire mesh, a slatted floor made of treated wood, a plastic panel, or a metal mesh covered in plastic. The platform 112 may also be formed in various sections, or may be a single integral platform 112.

In operation, chickens in house 100 may walk around predominantly on litter 106. However, in the area of the house 100 which is most likely to have wet litter 106—the nourishment area 108—the platform 112 is present to raise the chickens off of the litter 106. This combination of litter 106 and platform 112 keeps the chickens from encountering the wet areas of litter 106 while still allowing them the option of walking on litter 106 most of the time. The nourishment area as illustrated in FIGS. 1-6 is clearly sized to be a relatively small portion of an entire surface area of the floor such that a poultry is able to walk on litter over most of the surface area of the floor.

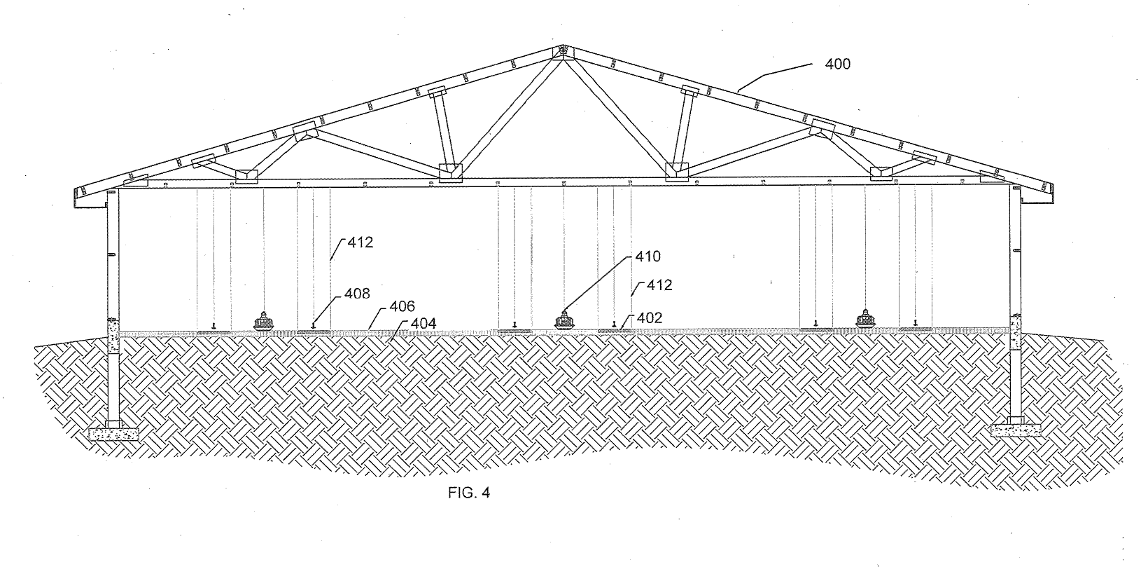

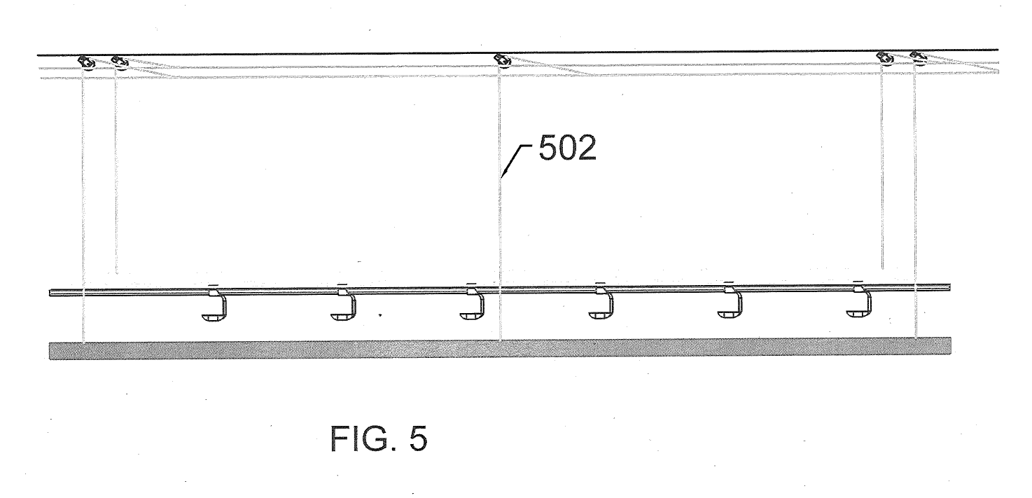

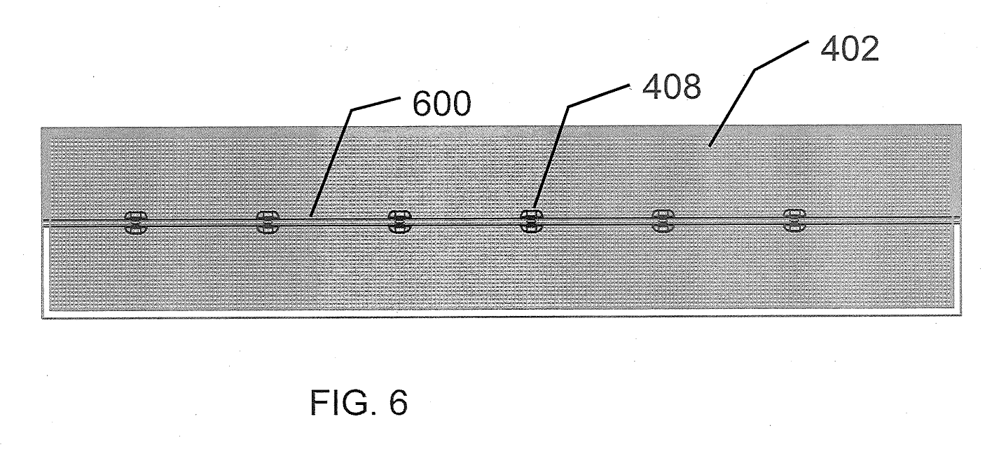

FIG. 4 is an illustration of a broiler house 400 cross section exposing an interior configuration. The house can have a compacted earth floor 404 over which a poultry bedding 406 is laid, which can be traditional litter. The mesh slatted floor 402 can be placed immediately over the poultry bedding material 406. The watering trough or poultry drinker 408 can be positioned above the mesh flooring. The trough 408 and the slatted floor can have cable winching attached thereto such that the troughs and slatted floors can be raised to a stowed position for cleaning and maintenance of the house in those areas. The cable winch for the slatted flooring is illustrated by item 412. The poultry feeder or feeding trough 410 is also illustrated. A cable winch system can also be attached to the feeding trough in a manner similar to that of the slatted flooring and the watering trough. As is illustrated in this FIG. 4 the slatted flooring or platform can partition a relatively small portion of the entire surface area of the floor and is positioned under the watering troughs. FIG. 5 further illustrates the watering supply lines, which provide water to the troughs. The troughs are also more generally referred to as drinkers or nourishment dispensing device and often referred to as nipple waterers, nipples or fountains. These terms can be used interchangeably herein and the use if either term does not narrow the scope of the claimed invention. The cable winch of the slatted floor is further illustrated by item 502. FIG. 6 provides a top view illustration showing the watering supply lines 600 adapted to provide water to the troughs 408. The slatted floor 402 is shown aligned directly beneath the watering troughs.

Thus, there has been shown and described several embodiments of an improved poultry house with a litter floor and a platform above the litter floor in a nourishment area of the house. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering this specification and the accompanying drawings. All such changes, modifications, variations and other uses and applications which do not depart from the spirit and scope of the invention are deemed to be covered by the invention which is limited only by the claims which follow. All defined terms used in the application are intended to be given their broadest reasonable constructions consistent with the definitions provided herein. All undefined terms used in the claims are intended to be given their broadest reasonable constructions consistent with their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

What is claimed is:

1. A poultry house comprising
a floor with a surface area;
litter substantially covering the surface area of the floor;
a nourishment area that is a portion of the surface area of the floor above which a nourishment dispensing device resides, where the nourishment area is relatively sized to be a relatively small portion of an entire surface area of the floor such that a poultry is able to walk on litter over most of the surface area of the floor;
said nourishment dispensing device configured to provide nourishment to the poultry, said nourishment device being located above the floor and above the litter above the nourishment area; and
a platform having a flat upper surface oriented substantially horizontal and substantially parallel to the floor and located above and in the nourishment area and said platform disposed immediately above the litter and floor, and below the nourishment dispensing device, said platform extending across substantially the entire nourishment area.

2. The poultry house of claim 1, wherein the platform is a grate with a plurality of through-holes which permit the droppings and water to pass through the grate.

3. The poultry house of claim 2, wherein the grate is sized such that the poultry standing on the grate and are kept from touching the litter or the floor directly below the grate in the nourishment area.

4. The poultry house of claim 2, wherein the plurality of through-holes have diameters smaller than the diameter of a foot of a day old chicken.

5. The poultry house of claim 2, wherein the grate is made from a material selected from the group consisting of a metal, a wood, a plastic, and a combination thereof.

6. The poultry house of claim 2, wherein the grate is a wire mesh, a wooden slatted floor, or a plastic panel.

7. The poultry house of claim 2, wherein platform is positioned immediately on top of the litter.

8. The poultry house of claim 7, wherein the litter extends up partially but not fully through the through-holes.

9. The poultry house of claim 1, wherein the platform is raised about at least about 1 cm above the litter.

10. The poultry house of claim 1, wherein the platform is raised more than about 5 cm above the litter.

11. The poultry house of claim 1, wherein the platform is substantially water proof.

12. The poultry house of claim 1, wherein the platform is substantially impermeable to bacteria.

13. The poultry house of claim 1, wherein the nourishing dispensing device is a water trough.

14. A method for elevating poultry off a litter floor in a poultry house, the method comprising:
providing a poultry house with a floor substantially covered by litter;
selecting a watering area beneath a watering trough, where the watering area is sized to be a relatively small portion of the entire floor such that a poultry is able to walk on litter over most of the floor;
providing a grate above the litter floor and below the watering trough in the watering area, the grate extending throughout the watering area.
